(19) United States
(12) Patent Application Publication
(10) Pub. No.: US 2017/0066922 A1
(43) Pub. Date: Mar. 9, 2017

(54) POLYAMIDE RESIN COMPOSITION

(71) Applicant: TOYOBO CO., LTD., Osaka (JP)

(72) Inventor: Nobuhiro YOSHIMURA, Shiga (JP)

(73) Assignee: TOYOBO CO., LTD., Osaka (JP)

(21) Appl. No.: 15/122,434

(22) PCT Filed: Mar. 3, 2015
(86) PCT No.: PCT/JP2015/056142

§ 371 Date: Aug. 30, 2016

(30) Foreign Application Priority Data
Mar. 5, 2014 (JP) 2014-042573

(51) Int. Cl. C08L 77/02

(52) U.S. Cl. CPC C08L 77/02; C08L 2205/025

(57) ABSTRACT

The present invention provides a polyamide resin composition containing 1 to 10 part (s) by mass of swellable layered silicate and 0.01 to 0.3 part by mass of a phosphorus-containing compound having 3 or less phosphorus oxidation number to 100 parts by mass of polyamide resins, characterized in that, the polyamide resins comprise a polyamide resin A₁ having relative viscosity of from 3.0 to 4.0 and a polyamide resin A₂ having relative viscosity of from 1.5 to less than 3.0, that their mixing rate A₁/A₂ (in terms of ratio by mass) is from 98/2 to 5/95, and that tensile elongation at break of the polyamide resin composition is 3.0% or more. The polyamide resin composition has tenacity which has not been achieved in the conventional nano-composite and has excellent strength, rigidity and hot rigidity in spite of small content of inorganic filler and specific gravity.

### TECHNICAL FIELD OF THE INVENTION

The present invention relates to a polyamide resin composition. More particularly, it relates to a polyamide resin composition containing swellable layered silicate and having tenacity and, in spite of its low specific gravity, being excellent in strength, rigidity and hot rigidity.

### BACKGROUND ART

Since a polyamide resin such as polyamide 6 or polyamide 66 has excellent mechanical characteristics, shock resistance and resistance to chemicals, it has been frequently used for automobile parts, electric parts, electronic parts, etc. after being reinforced with an inorganic filler. However, even when mechanical strength and heat resistance of a reinforced polyamide resin are enhanced, it often happens that tenacity which is inherent to the polyamide resin is deteriorated because the inorganic filler has poor affinity for polyamides.

Recently, there has been a proposal for the so-called nano-composite wherein layered silicate such as montmorillonite is added in a material monomer for a polyamide resin followed by polymerizing so that the layered silicate is dispersed in a nano order (Patent Documents 1, 2, etc.).

It has been said that, as compared with a composite material filled with a conventional inorganic filler, the nano-composite can exhibit higher elasticity and heat resistance using small amount of an inorganic filler and can be made its weight light. It is sure that the nano-composite prepared as such can express relatively high elasticity and heat resistance using small amounts of an inorganic filler.

However, when it is compared with a natural product containing no inorganic filler, a decrease in tenacity is significant. In some uses, mechanical strength becomes insufficient due to the insufficient tenacity. Accordingly, there is yet room for improvement in this point.

### PRIOR ART DOCUMENTS

### Patent Documents

Patent Document 1: Japanese Patent Application Laid-Open (JP-A) No. 7729/91
Patent Document 2: Japanese Patent No. 2941159

### DISCLOSURE OF THE INVENTION

### Problem that the Invention is to Solve

An object of the present invention is to provide a polyamide resin composition having tenacity which has not been achieved in the conventional nano-composite and having excellent strength, rigidity and hot rigidity in spite of small content of inorganic filler and specific gravity.

### Means for Solving the Problem

The present inventor has achieved the present invention after his extensive investigations.

Thus, the present invention is as follows.

(1) A polyamide resin composition containing 1 to 10 part(s) by mass of swellable layered silicate and 0.01 to 0.3 part by mass of a phosphorus-containing compound having 3 or less phosphorus oxidation number to 100 parts by mass of polyamide resins, characterized in that, the polyamide resins comprise a polyamide resin A₁ having relative viscosity of from 3.0 to 4.0 and a polyamide resin A₂ having relative viscosity of from 1.5 to less than 3.0, that their mixing rate A₁/A₂ (in terms of ratio by mass) is from 98/2 to 5/95, and that tensile elongation at break of the polyamide resin composition is 3.0% or more.

(2) The polyamide resin composition according to (1), wherein the phosphorus-containing compound having 3 or less phosphorus oxidation number is a hypophosphite.

### Advantages of the Invention

According to the polyamide resin composition of the present invention, it is now possible to provide a molded product which has tenacity being unable to be achieved in the conventional nano-composite and which can enhance strength, rigidity and hot rigidity of a polyamide resin in spite of small content of an inorganic filler and specific gravity.

### BEST MODE FOR CARRYING OUT THE INVENTION

Hereinafter, the present invention will be more specifically illustrated.

The polyamide resins (A₁ and A₂) used in the present invention stand for a polymer having an amide bond formed from amino acid, lactam or diamine with dicarboxylic acid. Examples of a monomer which forms a polyamide are as follows.

Examples of the amino acid are 6-aminocaproic acid, 11-aminoundecanoic acid, 12-aminododecanoic acid and p-aminomethylbenzoic acid.

Examples of the lactam are ε-caprolactam and ω-laurolactam.

Examples of the diamine are tetramethylenediamine, hexamethylenediamine, undecamethylenediamine, dodecamethylene-diamine, 2,2,4-/2,4,4-trimethylhexamethylenediamine, 5-methylnonamethylenediamine, 2,4-dimethyloctamethylenediamine, m-xylylene-diamine, p-xylylenediamine, 1,3-bis(aminomethyl)cyclohexane, 1-amino-3-aminomethyl-3,5,5-trimethylcyclohexane, 3,8-bis(aminomethyl)tricyclodecane, bis(4-aminocyclohexyl)methane, bis(3-methyl-4-aminocyclohexyl)methane, 2,2-bis(4-aminocyclohexyl)propane, bis(aminopropyl)piperazine and aminoethylpiperazine.

Examples of the dicarboxylic acid are adipic acid, suberic acid, azelaic acid, sebacic acid, dodecane-dioic acid, terephthalic acid, isophthalic acid, naphthalenedicarboxylic acid, 2-chloro-terephthalic acid, 2-methylterephthalic acid, 5-methylisophthalic acid, 5-sodiumsulfo-isophthalic acid, hexahydroterephthalic acid, hexahydroisophthalic acid and diglycolic acid.

As the polyamide resin used in the present invention, preferred ones are polycaproamide (polyamide 6), polytetramethyleneadipamide (polyamide 46), polyhexamethyleneadipamide (polyamide 66), polyhexamethylenesebacamide (polyamide 610), polyhexamethylenedodecamide (polyamide 612), polyundecamethyleneadipamide (polyamide 116), polyundecaneamide (polyamide 11), polydodecaneamide (polyamide 12), polytrimethylhexamethyleneterephthalamide (polyamide TMHT), polyhexamethyleneisophthalamide (polyamide 61), polyhexamethyleneterephthal/isophthalamide (polyamide 6T/6I), polybis(4-aminocyclohexyl)methanedodecamide (polyamide PACM 12), polybis(3-methyl-4-aminocyclohexyl)methanedodecamide (polyamidodimethyl PACM 12), poly-m-xylyleneadipamide (polyamide MXD 6), polyundecamethyleneterephthalamide (polyamide 11T), polyundecamethylenehexahydroterephthalamide (polyamide 11T(H)) and copolymerized amide, mixed amide, etc. thereof. Among them, the particularly preferred ones are polyamide 6, polyamide 46, polyamide 66, polyamide 11, polyamide 12 and a copolymerized amide thereof or a mixed polyamide thereof.

The polyamide resin used here is usually produced by a known melt polymerization method or by a solid phase polymerization method together therewith. Relative viscosity of the polyamide resin is preferred to be from 1.5 to 4.0.

The relative viscosity of the polyamide resin in the present invention is measured using concentrated sulfuric acid of 96% by mass as a solvent under the condition wherein temperature is 25° C. and concentration is 1 g/dl.

The present invention uses mixed polyamide resins comprising a polyamide resin A₁ having relative viscosity of from 3.0 to 4.0 and a polyamide resin A₂ having relative viscosity of from 1.5 to less than 3.0. As to the relative viscosity of the polyamide resin A₁, it is preferred to be from 3.2 to 3.8. As to the relative viscosity of the polyamide resin A₂, it is preferred to be from 1.7 to 2.8. It is necessary that, the relative viscosity of the polyamide resin A₁ and the relative viscosity of the polyamide resin A₂ are different from each other. Difference in the relative viscosity of the polyamide resin A₁ and the relative viscosity of the polyamide resin A₂ is preferred to be from 0.3 to 2.0, more preferred to be from 0.5 to 1.6, and still more preferred to be from 0.7 to 1.4.

The mixing rate A₁/A₂ (in terms of ratio by mass) of the polyamide resin A₁ to the polyamide resin A₂ is from 98/2 to 5/95, preferably from 95/5 to 40/60, and more preferably from 95/5 to 50/50. It is not preferred that the polyamide resin A₁ is more than 98% by mass because, as a result thereof, fluidity upon molding is insufficient whereby smoothness of the surface of the molded product prepared from the polyamide resin composition and decorative property thereof become bad. When the polyamide resin A₁ is less than 5% by mass, it is not preferred as well because tensile elongation at break cannot be retained.

It is preferred that the polyamide resin A₁ and the polyamide resin A₂ are the polyamide resins in the same species. In that case, the term reading the same species means that 90 molar % or more of the constituent monomer species are same.

As a result of using the two kinds of polyamide resins in the same species having different relative viscosities as such, tensile elongation at break (%) of the resulting molded product becomes high and tenacity of the molded product is much more enhanced.

The swellable layered silicate used in the present invention may be any of natural swellable layered silicate produced in nature and synthetic swellable layered silicate prepared by synthesis. The term reading “swellable” is such a property that the layered silicate is swollen when a solvent such as water, alcohol or ether invades into an area among crystal layers of the layered silicate.

As to the swellable layered silicate used in the present invention, it is preferred to be such a one having a structure of a 2:1 type wherein tetrahedral sheets of silicic acid are piled on and below an octahedral sheet containing metal such as aluminum, magnesium or lithium so as to form a plate-shaped crystal layer. In that case, an exchangeable cation exists between the layers of the plate-shaped crystal layer.

As to size of the single plate-shaped crystal, it is preferred that width is from 0.05 to 0.5 μm and thickness is from 6 to 15 Å. A cation-exchange capacity of the exchangeable cation is preferred to be from 0.2 to 3 meq/g, and more preferred to be from 0.8 to 1.5 meq/g.

Specific examples of the swellable layered silicate are clay minerals of a smectite type such as montmorillonite, beidellite, nontronite, saponite, hectorite and sauconite; various clay minerals such as vermiculite, halloysite, kanemite, kenyaite, zirconium phosphate and titanium phosphate; and swellable mica such as fluor-taeniolite of a lithium type, fluor-taeniolite of a sodium type, tetrasilicon fluor-mica of a sodium type and tetrasilicon fluor-mica of a lithium type. They may be either natural or synthetic. Among them, preferred ones are clay minerals of a smectite type such as montmorillonite and hectorite and swellable mica such as tetrasilicon fluor-mica of a sodium type and fluor-taeniolite of a lithium type and the particularly preferred one is montmorillonite.

In the present invention, it is preferred to use a swellable layered silicate in which an exchangeable cation existing among the layers has been exchanged with an organic onium ion.

As to the swellable layered silicate as such, Somasif MEE (manufactured by Co-op Chemical) and Nanoclay I.30T (manufactured by Nanocor) can be used.

As to the organic onium ion, there may be exemplified ammonium ion, phosphonium ion and sulfonium ion. Among them, ammonium ion and phosphonium ion are preferred and ammonium ion is used particularly preferably. As to the ammonium ion, it may be any of primary ammonium, secondary ammonium, tertiary ammonium and quaternary ammonium.

As to the primary ammonium ion, there may be exemplified decylammonium, dodecylammonium, octadecylammonium, oleylammonium and benzylammonium.

As to the secondary ammonium, there may be exemplified methyl dodecylammonium and methyl octadecylammonium.

As to the tertiary ammonium, there may be exemplified dimethyl dodecylammonium and dimethyl octadecylammonium.

As to the quaternary ammonium ion, there may be exemplified benzyl trialkylammonium ion such as benzyl trimethylammonium, benzyl triethylammonium, benzyl tributylammonium, benzyl dimethyl dodecylammonium and benzyl dimethyl octadecylammonium; alkyl trimethylammonioum ion such as trimethyl octylammonium, trimethyl dodecylammonium and trimethyl octadecylammonium; dimethyl dialkylammonium ion such as dimethyl dioctylammonium, dimethyl didodecylammonium and dimethyl dioctadecylammonium; and trialkyl methylammonium ion such as trioctyl methylammonium and tridodecyl methylammonium.

Besides those, there may be also exemplified ammonium ion derived from aniline, p-phenylenediamine, α-naphthylamine, p-aminodimethylaniline, benzidine, pyridine, piperidine, 6-aminocaproic acid, 11-aminoundecanoic acid, 12-aminododecanoic acid or the like.

Among those ammonium ions, preferred one is a quaternary ammonium ion and its examples are trioctyl methylammonium, trimethyl octadecylammonium, benzyl dimethyl octadecylammonium and an ammonium ion which is derived from 12-aminodecanoic acid. Particularly, trioctyl methylammonium and benzyl dimethyl octadecylammonium are most preferred.

In the present invention, swellable layered silicate in which an exchangeable cation existing among the layers has been exchanged with an organic onium ion can be produced by reacting swellable layered silicate having an exchangeable cation among the layers with an organic onium ion by means of a known method. To be more specific, there may be exemplified a method wherein an ion-exchange reaction is carried out in a polar solvent such as water, methanol or ethanol and a method wherein the swellable layered silicate is directly reacted with a liquid or a melted ammonium salt.

In the present invention, amount of an organic onium ion to the swellable layered silicate is usually within a range of from 0.4 to 2.0 equivalent(s), preferably from 0.8 to 1.2 equivalent(s), to a cation exchange capacity of the swellable layered silicate in view of dispersibility of the swellable layered silicate, thermal stability upon melting and suppression of gas and smell upon molding.

Content of the swellable layered silicate is 1 to 10 part(s) by mass to 100 parts by mass of the polyamide resins. When it is less than 1 part by mass, tensile strength and heat distortion temperature are not sufficient while, when it is more than 10 parts by mass, tensile elongation at break and impact strength significantly lower. The content of the swellable layered silicate is preferred to be from 3 to 8 parts by mass, and more preferred to be from 3 to 6 parts by mass.

As to the phosphorus-containing compound having 3 or less phosphorus oxidation number used in the present invention, there may be exemplified disodium phosphite, dimethyl phosphite, diethyl phosphite, diphenyl phosphite, trimethyl phosphite, triethyl phosphite, triphenyl phosphite, sodium hypophosphite and calcium hypophosphite. It is particularly preferred to use a metal phosphite or a metal hypophosphite. As to the metal for the metal phosphite or the metal hypophosphite, that which is selected from alkali metal, alkali earth metal and zinc group is preferred and the more preferred one is alkali metal. As to the phosphorus-containing compound having 3 or less phosphorus oxidation number, the particularly preferred one is sodium hypophosphite.

Compounding amount of the phosphorus-containing compound having 3 or less phosphorus oxidation number is 0.01 to 0.3 part by mass, preferably 0.05 to 0.2 part by mass, to 100 parts by mass of the polyamide resins. When it is less than 0.01 part by mass, no rise in the melting viscosity is achieved while, when it is more than 0.3 part by mass, melting viscosity rises too much whereby the molding becomes difficult.

In a reinforced polyamide resin composition according to the present invention, tensile elongation at break (%) of the polyamide resin composition is 3.0% or more. The tensile elongation at break is measured by a method mentioned in the item of the following Examples. Although an upper limit of the tensile elongation at break of the polyamide resin composition is not particularly stipulated, it may be sometimes about 100%. Since the tensile elongation at break as such is acheived, tenacity and shock resistance of the molded product formed of the polyamide resin composition become high and that is preferred.

Although the reason therefor is not clear, it is likely that a thickening action of the polyamide resins is expressed by the phosphorus-containing compound having 3 or less phosphorus oxidation number.

In addition to the above, it is also possible, if necessary, to further add light or heat stabilizer, antioxidant, ultraviolet absorber, light stabilizer, plasticizer, lubricant, crystal nucleating agent, releasing agent from mold, antistatic agent, a combination of flame retardant of a halogen type with antimony trioxide, various kinds of flame retardants of a phosphate type, flame retardant of a melamine type, inorganic pigment, organic pigment, dye or polymers of other type, to the reinforced polyamide resin composition of the present invention.

Total amount of the essential ingredients which are polyamide resins, swellable layered silicate and a phosphorus-containing compound having 3 or less phosphorus oxidation number occupies preferably 90% by mass or more, and more preferably 95% by mass or more, of the polyamide resin composition of the present invention.

As an example of a method for producing the polyamide resin composition of the present invention, each of the above-mentioned ingredients and other compounding substance in the above compounding composition are compounded in any compounding order and then mixed using a tumbler, a Henschel mixer or the like to subject to melt kneading. As to a method for the melt kneading, any method which has been known among persons skilled in the art is applicable. Although there may be used uniaxial extruder, biaxial extruder, kneader, Banbury mixer, roll, etc., it is particularly preferred to use a biaxial extruder.

Further, in order to remove evaporating ingredients and decomposed low-molecular ingredients upon processing, it is desirable to conduct suction by a vacuum pump between a side opening and a die head at a front end of the extruder.

The polyamide resin composition of the present invention can be produced by such a very simple method that a polyamide resin A₁ having relative viscosity of from 3.0 to 4.0, a polyamide resin A₂ having relative viscosity of from 1.5 to less than 3.0, swellable layered silicate and a phosphorus-containing compound having 3 or less phosphorus oxidation number are subjected to melt kneading in the above-mentioned compounding ratio.

### EXAMPLES

As hereunder, the present invention will be specifically illustrated by referring to Examples and Comparative Examples although the present invention is not limited to those Examples.

(1) Materials Used

[Polyamide Resin]

Polyamide (1): Polyamide 6 (relative viscosity: 3.5), TP-6603 (manufactured by Shuseisha)

Polyamide (2): Polyamide 6 (relative viscosity: 2.5), TP-4208 (manufactured by Shuseisha)

Polyamide (3): Polyamide 6 (relative viscosity: 3.7), T-850 (manufactured by Toyobo)

Polyamide (4): Polyamide 6 (relative viscosity: 1.9), T-860 (manufactured by Toyobo)

[Swellable Layered Silicate]

Swellable layered silicate (1): Somasif MEE (manufactured by Co-op Chemical); Organically-modified lipophilic swellable mica wherein an organic cation is carried among the layers by utilizing a cation-exchange ability of a hydrophilic swellable mica.

Swellable layered silicate (2): Nanoclay 1.30T (manufactured by Nanocor); Swellable layered silicate in which an exchangeable cation existing among the layers has been exchanged with an organic onium ion.

Swellable layered silicate (3): Swellable fluorine mica ME-100 (manufactured by Co-op Chemical)

[Non-Swellable Silicate]

Non-swellable silicate: Micromica MK-100 (manufactured by Co-op Chemical)

[A Phosphorus-Containing Compound Having 3 or Less Phosphorus Oxidation Number]

Sodium hypophosphite

(2) Method for Measuring Characteristics and Physical Property Data

Relative Viscosity (RV):

Measurement was conducted by an Ubbelohde's viscometer using concentrated sulfuric acid of 96% by mass as a solvent under the condition wherein temperature was 25° C. and concentration was 1 g/dl.

Density:

Measurement was conducted in accordance with ISO 1183.

Tensile strength, tensile elasticity and tensile elongation at break:

IS-100 manufactured by Toshiba Machine was used, temperature of a cylinder was set at 250° C. and a molded product was prepared in accordance with ISO 527-1 under the condition wherein temperature of a metal mold was 130° C. and, after that, measurement was conducted in accordance with ISO 178. The measurement was done in five levels and mean values thereof was adopted.

Heat Distortion Temperature (HDT):

IS-100 manufactured by Toshiba Machine was used, temperature of a cylinder was set at 250° C. and a molded product was prepared in accordance with ISO 527-1 under the condition wherein temperature of a metal mold was 130° C. and, after that, measurement was conducted in accordance with ISO 75-1,2.

### Examples 1 to 8 and Comparative Examples 1 to 5

Samples for the evaluation was produced in such a manner that the materials were weighed in the ratio by mass as shown in Table 1, mixed in a tumbler and subjected to melt kneading using a biaxial kneader with L/D of 32 at the kneading temperature of 250° C. to give pellets. The resulting pellets of a polyamide resin composition were molded into various samples for the evaluation using an injection molding machine. Results of the evaluation are shown in Table 1.

### Comparative Example 6

During the polymerization of ε-caprolactam, a swellable fluorine mica ME-100 (manufactured by Co-op Chemical) was added as a swellable layered silicate and, in accordance with a method mentioned in the gazette of JP 2007/231076 A, there was prepared a polyamide resin composition of polyamide 6 resin having relative viscosity of 2.5 and containing 4.0% by mass of the swellable fluorine mica. Results of the evaluation are shown in Table 1.

| | | Examples | | | | | | | | Comparative Examples | | | | | |
|---|---|---|---|---|---|---|---|---|---|---|---|---|---|---|---|
| | | 1 | 2 | 3 | 4 | 5 | 6 | 7 | 8 | 1 | 2 | 3 | 4 | 5 | 6 |
| compounding | Polyamide (1) | 91 | | 87 | 91 | 48 | 91 | 91 | 87 | 100 | 95 | 91 | 95 | | |
| amount · | (RV: 3.5) | | | | | | | | | | | | | | |
| part(s) | Polyamide (2) | 5 | 5 | 5 | | 48 | 5 | 5 | 5 | | 5 | 5 | | 96 | |
| by mass | (RV: 2.5) | | | | | | | | | | | | | | |
| | Polyamide (3) | | 91 | | | | | | | | | | | | |
| | (RV: 3.7) | | | | | | | | | | | | | | |
| | Polyamide (4) | | | | 5 | | | | | | | | | | |
| | (RV: 1.9) | | | | | | | | | | | | | | |
| | Polyamide | | | | | | | | | | | | | | 96 |
| | (RV: 2.5) | | | | | | | | | | | | | | |
| | Swellable layered | 4 | 4 | 8 | 4 | | | | | | | 4 | | 4 | |
| | silicate (1) | | | | | | | | | | | | | | |
| | Swellable layered | | | | | 4 | 4 | 4 | 8 | | | | | | |
| | silicate (2) | | | | | | | | | | | | | | |
| | Swellable layered | | | | | | | | | | | | | | 4 |
| | silicate (3) | | | | | | | | | | | | | | |
| | Non-swellable | | | | | | | | | | | | 5 | | |
| | silicate | | | | | | | | | | | | | | |
| | Sodium | 0.1 | 0.1 | 0.1 | 0.1 | 0.1 | 0.1 | 0.5 | 0.1 | | 0.1 | | | 0.1 | |
| | hypophosphite | | | | | | | | | | | | | | |
| composition | Density (g/cm³) | 1.15 | 1.15 | 1.16 | 1.16 | 1.15 | 1.15 | 1.15 | 1.16 | 1.14 | 1.14 | 1.15 | 1.15 | 1.15 | 1.15 |
| characteristics | Tensile | 85 | 84 | 97 | 84 | 84 | 90 | 87 | 105 | 68 | 69 | 85 | 62 | 89 | 92 |
| | strength (MPa) | | | | | | | | | | | | | | |
| | Tensile | 3.9 | 3.9 | 5.2 | 3.9 | 3.9 | 4.1 | 3.9 | 5.5 | 3.0 | 3.1 | 3.9 | 4.0 | 3.9 | 4.1 |
| | elasticity (GPa) | | | | | | | | | | | | | | |
| | Tensile elongation | 20 | 25 | 3.4 | 5.3 | 17 | 18 | 25 | 3.2 | >200 | >200 | 2.6 | 1.6 | 2.6 | 2.6 |
| | at break (%) | | | | | | | | | | | | | | |
| | HDT, high | 90 | 90 | 104 | 90 | 90 | 95 | 90 | 110 | 55 | 54 | 90 | 81 | 95 | 132 |
| | load (° C.) | | | | | | | | | | | | | | |

In Examples 1 to 8, HDT under high load is 80° C. or higher and tensile elongation at break is 3% or more whereby excellent heat resistance and tenacity are achieved in spite of the fact that all of them have low specific gravity of as low as 1.16 g/cm³ or less in terms of density. On the contrary, in Comparative Examples 1 and 2, although tensile elongation at break is as high as 200% or more, HDT is 55° C. whereby heat resistance is low. In Comparative Examples 3 to 6, although HDT is high, tensile elongation at break is lower than 3%.

### INDUSTRIAL APPLICABILITY

The polyamide resin composition of the present invention can provide a molded product having tenacity, exhibiting low specific gravity and being excellent in strength, rigidity and hot rigidity. Accordingly, it is suitable for the uses such as interior and exterior furnishing parts for automobiles represented by door handles, parts for home electric appliances, etc.

1. A polyamide resin composition containing 1 to 10 part(s) by mass of swellable layered silicate and 0.01 to 0.3 part by mass of a phosphorus-containing compound having 3 or less phosphorus oxidation number to 100 parts by mass of polyamide resins, characterized in that, the polyamide resins comprise a polyamide resin A₁ having relative viscosity of from 3.0 to 4.0 and a polyamide resin A₂ having relative viscosity of from 1.5 to less than 3.0, that their mixing rate A₁/A₂ (in terms of ratio by mass) is from 98/2 to 5/95, and that tensile elongation at break of the polyamide resin composition is 3.0% or more.

2. The polyamide resin composition according to claim 1, wherein the phosphorus-containing compound having 3 or less phosphorus oxidation number is a hypophosphite.
